(19) United States
(12) Patent Application Publication
(10) Pub. No.: US 2010/0225989 A1
(43) Pub. Date: Sep. 9, 2010

(54) PHASE CHANGE DEVICE

(75) Inventor: Andre Anders, El Cerrito, CA (US)

Correspondence Address: LAWRENCE BERKELEY NATIONAL LABORATORY, Technology Transfer & Intellectual Propery Managem, One Cyolotron Road MS 56A-120, BERKELEY, CA, 94720, US

(73) Assignee: The Regents of the University of California, Oakland, CA (US)

(21) Appl. No.: 12/716,838

(22) Filed: Mar. 3, 2010

Related U.S. Application Data
(60) Provisional application No. 61/157,825, filed on Mar. 5, 2009.

(51) Int. Cl. G02F 1/19

(52) U.S. Cl. 359/288

(57) ABSTRACT

A phase change material is applied as a very thin film to a transparent substrate such as glass, which material when switched from the amorphous to the crystalline state and back again can affect the reflectivity/transmittance of the combined substrate-coating system. When used with glass panels in the fabrication of relatively large area window glass, the change in spectrally selective transmittance can be used to modulate the amount of sunlight passing through the glass, and thus reduce the amount of cooling required for an interior space in the summertime, and the amount of heating required of that same interior space in the wintertime, while also optimizing the use of visible daylight. Exemplary of a suitable phase change material for glass coating is GeSb or BiSn. Heating of the phase change material to initiate a change in phase can be provided by the application of electric energy, such as supplied from a pulsed power supply, or radiant energy, such as from a laser.

### CROSS REFERENCE TO RELATED APPLICATIONS

This application claims priority to U.S. Provisional Patent Application Ser. No. 61/157,825, filed Mar. 5, 2009, and entitled Phase Change Device, Andre Anders inventor, the contents of said application incorporated herein by reference in its entirety and for all purposes.

### STATEMENT OF GOVERNMENTAL SUPPORT

The invention described and claimed herein was made in part utilizing funds supplied by the U.S. Department of Energy under Contract No. DE-AC02-05CH11231. The government has certain rights in this invention.

### BACKGROUND OF THE INVENTION

1. Field of the Invention

This invention relates generally to phase change materials, and, more specifically, to dynamic windows incorporating phase change materials for regulation of their spectrally selective transmittance, and thus their energy efficiency.

2. Description of the Related Art

As part of an attempt to create more energy efficient buildings, there is a lot of interest in ways to improve the thermal insulation properties of windows during the daytime (especially during summer months) to control natural room heating as a result of solar radiation, and thus reduce cooling requirements necessary to maintain comfortable conditions for human occupancy. Use of window shades is one of the classic methods for controlling radiation, in combination with dual pane windows which rely, in part, on the presence of a thermally isolating space between the glass panes, usually filled with a low conductivity gas such as argon, to reduce heat transfer between one side of the window and the other.

Other approaches to improved energy efficiency have looked to converting windows from their current role as “energy users” (their presence causing increases in energy use for heating in winter and cooling in summer) to that of net energy suppliers. This goal can be achieved through dynamic glazings that can modulate solar heat gain. Incident solar energy depends on many factors such as the time of the day, season, climate, weather conditions, orientation of the window, and the like. To reduce overall energy consumption while also satisfying occupant needs thus requires dynamic response of the optical properties of the window to these variables. Dynamic glazings (coatings) save energy by directly reducing cooling loads, by offsetting electric lighting energy requirements through the effective use of glare-free daylight, and by allowing windows to act as passive solar collectors in winter, and to reject solar gain so as to prevent overheating in summer.

Current technology for dynamic windows utilizes a range of electrochromic materials, the most successful or which to-date is tungsten oxide, which reversibly turns from clear to deep blue when intercalated with protons (hydrogen ions) or lithium or sodium ions. There are other classes of dynamic materials such as photochromic (darken with increasing incident UV light) or thermochromic (darken when the temperature increases above a certain threshold, e.g. about 65° C. for VO₂), but these types of materials cannot be controlled by the occupant of a room and are therefore not widely used or preferred for buildings applications. Dynamic windows, especially skylights, are now in the market, including those made by SAGE Electrochromics, Inc. An alternative concept, gasochromic switching, was developed by Interpane Glass Industrie AG, Germany, but was not further pursued by this company. Alternative electrochromic materials have been investigated, such as the rare earth and transition metal alloys as described in U.S. Pat. No. 5,635,729 and U.S. Pat. No. 6,647,166, which transform to metal hydride phases. Yet other alternative materials which have been investigated include copper antimony alloys which switch when lithium is inserted, such as described in U.S. Pat. No. 7,042,615.

In all of the above examples, ions are shuttled between an ion storage layer or similar ion reservoir and the layer of switchable material. In this way, the flow of radiant energy in the UV, visible, or near infrared (solar IR) can be modulated to obtain the desired benefits in energy savings via control of the amount of visible light and heat (infrared radiation) passing through the window. Since ion motion is involved, however, the process of switching is relatively slow, usually of the order of many seconds or minutes, before the desired change in the transmittance and/or reflectance of the material is observed.

Another approach to achieving dynamic, energy-efficient windows involves the use of thermochromic or photochromic materials, which are materials that switch optical properties by a heat-induced change in oxidation state (e.g. vanadium oxide) or by UV radiation. However, besides slow switching speed, such systems based on ion intercalation have been shown to have a generally limited lifetime, which is especially true for the less mature material systems (i.e. those other than the tungsten oxide system). Limited lifetime, slow switching speed, limited contrast, and relatively high cost have prevented broad market penetration of such energy efficient windows.

### SUMMARY OF THE INVENTION

By way of this invention, an improved switchable window is provided whereby its transmissivity/reflectivity may be rapidly changed using materials that rapidly undergo phase change under the influence of pulsed, transient heating. In one embodiment a very thin layer of such phase changeable material is deposited on a transparent medium such as glass, which in an illustrated embodiment is shown incorporated into an energy-efficient insulated glass unit (IGU).

Phase-change materials have been known for several decades but only recently have become a topic of research interest in the development of next generation information storage devices. Most prominently they are being used in well-known optical storage disks like DVD and Blu-Ray that rely on the writing and reading of information by creating and detecting tiny dots of amorphous phase-change material, i.e. dots of amorphous material in an otherwise crystalline layer. The amorphous material has a much lower reflectance and higher resistance than its crystalline counterpart. Thus in the writing process, a temperature pulse is applied (usually by laser using a short pulse) to a crystalline layer. The heated location is then rapidly cooled (“quenched”) to freeze the locally melted material to the amorphous phase. In the reading process, the laser is directed to the disk at much lower power to explore the locally reduced reflectivity, representing the digital information stored. With read/write optical disks, to erase the optical information represented by the amorphous “dots”, the disk surface is heated with medium power above the crystallization temperature.

While optical systems with phase change materials are already on the market, such as DVD and Blu-Ray, there is intense research on integrating them into electrically addressed non-volatile memory devices, so-called phase-change random-access memory or PCRAM. In this application, scaling to miniaturize the pattern of amorphous and crystalline phases is sought in order to achieve higher and higher densities of stored information. By way of the instant invention, however, scaling is taken in the other direction. That is, thin films of the same or similar types of phase-change materials can be used for large area switching of the optical properties of windows, particularly those used in residential and commercial buildings, i.e. up to the square-meter scale.

### BRIEF DESCRIPTION OF THE DRAWINGS

The foregoing aspects and others will be readily appreciated by the skilled artisan from the following description of illustrative embodiments when read in conjunction with the accompanying drawings.

The widths of the layers in FIGS. 1, 2 and 3 are not to scale, and not meant to convey any meaning concerning layer thicknesses. As will be later discussed in the Detailed Description, the glass layers as illustrated are in fact orders of magnitude greater than the thickness of the contact layers and the phase change layers as shown.

FIG. 1 is a cross section schematic diagram showing an embodiment of the invention.

FIG. 2 is a cross section schematic diagram showing another embodiment of the invention.

FIG. 3 is a cross section schematic diagram showing yet a third embodiment of the invention.

FIG. 4 is schematic front view of a glass pane with multiple bus bars that sub-divide the full window area into smaller, more manageable subareas, which are easier to electrically address.

FIG. 5 is a schematic of a still further embodiment of the invention, illustrating a sectioned insulated glass unit incorporating a phase change material, activated by a radiative energy source.

FIG. 6 is a three component ternary compositional diagram for Ge, Sb and Te.

### DETAILED DESCRIPTION

These and other objects and advantages of the present invention will become more fully apparent from the following description taken in conjunction with the accompanying drawings.

Described herein below is the use of a cost-effective, robust, layer system to be deposited on a transparent medium like glass where, for example, it can be incorporated into an affordable, energy-efficient insulated glass unit (IGU), the core of a modern window for residential and commercial buildings. Other potential applications include windows in vehicles, large area displays, roof panels, etc.

In the current invention, very thin films in the order of 10 nm of phase change materials of the type used in optical storage discs like DVD and Blu Ray are used for large areas where switching of the optical properties may be used to change the reflectivity of windows, such as used in residential and commercial buildings. The different optical properties of the phases are related to very different band structures and the change of the density of states, which depends upon the phase of the material (amorphous versus crystalline). In the amorphous state, the material is of high resistivity and low reflectance, while in the crystalline state, electrical conductivity is relatively high due to free electrons in the conduction band, and thus the reflectivity is high. Notably, both the real and imaginary parts of the complex refractive index are changed as the material switches between the amorphous and crystalline state.

The general principle of the phase-change device is as follows: Switching from a crystalline to an amorphous state occurs by a rapid, pulsed heating. The heating of the phase-change layer when in the crystalline state is rapidly taken to a temperature beyond the melting point. After abrupt termination of the heating pulse, the molten material is quickly quenched. As a result of the rapid cooling, the atoms of the material do not have sufficient time to re-arrange, that is to re-crystallize, and thus essentially freeze into a non-ordered state, known as the amorphous phase. In the amorphous phase, the material is in its most transparent form. The faster the rate of heating the better, with heating times in the micro second range, or even less, which will in turn promote rapid cooling. As some of the heat of the phase change layer will be transferred to adjacent layers, the hotter those adjacent layers become, the slower will be the rate of cool down of the phase change material. Generally, to be effective as a quench, cool down rates in the microsecond range or faster are required.

The amorphous material can then be re-crystallized by heating the material, for example, from ambient temperature to above the crystallization temperature but below the melting temperature (the melting temperature is higher than the crystallization temperature). In the re-crystallized phase, it is more reflecting, and thus less light goes through the film. In this heating step, the rate of heating and cooling is not as critical to the process as in the case of the transition from crystalline to amorphous. More important is the control of the maximum temperature so that the melting temperature is not approached or exceeded. Thus in heating the amorphous material to above the crystallization temperature, ramp rates in the millisecond range are sufficient, with cool down rates, possibly even slower. In the event of a temperature overshoot, and the melting point temperature is exceeded, crystallization can still occur if the rate of cooling is slow enough.

To achieve the fast switching of this invention, generally commercially available pulsed power supply units can be used. Given that relatively small voltages such as in the order of 100 volts or less are required, 100 volt pulsed DC power supply units can be employed, and the output stepped down as desired. With the pulsed supply, to change the material from its crystalline to amorphous phase, a pulse of relatively high heating power of short duration will be used. Once in the amorphous phase, to change the material back to its crystalline phase, where heating from ambient to only above the crystallization temperature is required, a lower heater power pulse of the same or longer duration is applied. The precise power levels can be determined by routine experimentation, depending in part upon the material chosen as the phase change material and the device design (e.g. its geometry).

To make the analogy to the widely used process in the information storage industry, amorphization is called “writing” of an amorphous dot in the otherwise crystalline film. Consistently, re-crystallization of this dot is considered “erasing” of the information. Writing and erasing are done with the same focused laser beam but at different power (e.g. using a blue laser for Blu-Ray disks). It is known that heating can be done not only by laser light but also electrically—as currently explored in ongoing research efforts (IBM, Philips, and other companies) towards novel solid state memory devices. Scaling efforts in this field aim to reduce the size of the switched area to the smallest possible, and erasing and writing requires identifying extremely fast responding materials. Transition times in the sub-microsecond region are typical for this field of science and engineering.

For the large area phase-change device disclosed herein, such extremely fast switching speeds are not needed because switching in milliseconds would appear to the eye as an instantaneous event. This opens the possibility to consider materials other than those used in the information storage industry. This is needed since most materials in that field are judged by switching speed in reflection and/or resistivity. The absorbance is often considered due to its effect on heating by a laser, if a laser is used, whereas overall transmission is only considered for multilayer devices. Total transmittance, however, is a very important property to be considered for window applications because, after all, windows are made to be looked through.

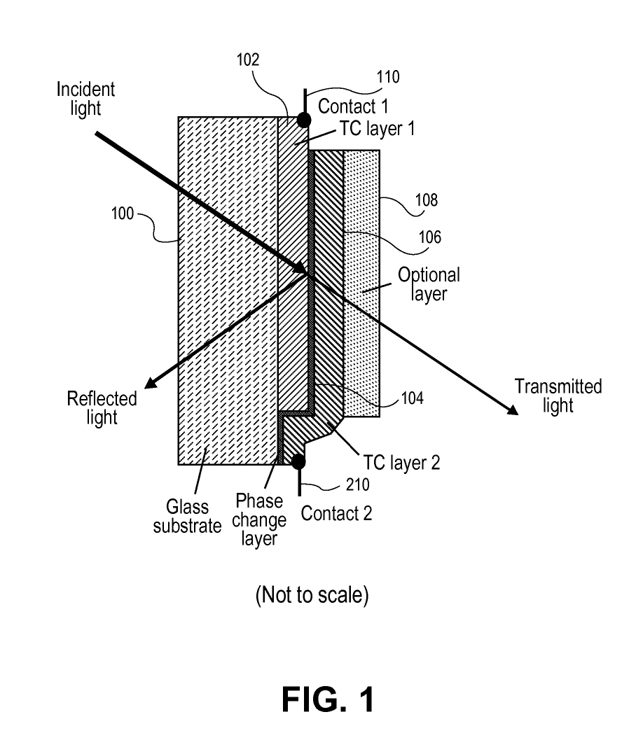

With reference now to FIG. 1, a transparent substrate 100 (typically a glass pane) coated with a transparent conductor 102 (e.g. indium tin oxide (ITO), or fluoride-doped tin oxide known as Tec-Glass, or the like) is coated with a thin film (typically between 5 and 50 nm thick) of a suitable phase-change material 104. On top of the phase-change material, a second transparent conductor 106 is deposited which represents the counter electrode. Additionally, final layer(s) 108 may be deposited for protection and/or to obtain desired antireflection properties. Typically with glass used in commercial windows for home or office, the thickness of the glass will be in the order of 1 to 5 mm, which is orders of magnitude larger than the thin film of phase change material.

In this embodiment of a layer system for a dynamic window based on phase-change layer, with the phase-change layer sandwiched between two transparent conducting (TC) layers, each conducting layer is provided with an electrical contact 110 and 210 for addressing the device. An additional layer (or several layers) can be added to obtain protection or antireflection properties. In the simplest case, however, the transparent electrodes can be designed to fulfill desirable mechanical, chemical, and optical properties, and no additional layers are needed. The function of the phase-change layer is to determine (modulate) the transmittance and reflectance of the device. In the example of this figure, the incident light comes from the transparent substrate side of the assemblage, and it is understood that the transmitted light emanating from the other side of the assemblage is modulated.

To achieve a change in the transmittance of the window, assuming it is first in the amorphous (more transparent) state to begin with, a short pulse of electricity can be applied though contacts 110 and 210. The current flowing from the one transparent conductor layer to the other will cause the temperature of the phase change layer to rapidly rise. The current should be of sufficient amplitude and the pulse of sufficient duration such that the phase change layer will be heated above the crystallization temperature but below the melting temperature to transition to the crystalline phase. With power to the conductor layers then terminated, the phase change layer cools, remaining in the crystalline phase. In this state, the reflectance is enhanced and thus the transmittance of the phase change layer is reduced. Once the material is in the crystalline phase, the process can be reversed by pulsing one of the conducting layers again, however, this time the pulse being of higher power to raise the temperature of the material above its melting point. The heating should be done very rapidly so as to not significantly heat the glass or other layers. In this way, the temperature of the phase change layer can drop quickly as the heating pulse is terminated, the material solidifying in the amorphous state before it has a chance to crystallize. This quick drop in temperature is sometimes called quenching, meaning sudden “freezing” of the atom arrangement and related materials properties.

Ideally the materials used in the phase change layer should have relatively low melting temperatures. For example, desirable melting temperatures would be in the range from 180° C. to 250° C. because on the one hand, the melting temperature should be low for the ease of melting, and on the other hand, melting should never happen in an uncontrolled manner, for example when a window is exposed to extreme summer heat and solar radiation. Notably, such seemingly high melting temperatures are not of concern to occupants, even though the windows are in an environment where they might easily be contacted by a building occupant at the time of phase change. This is so because in one embodiment, the phase change coating can be applied to a surface not touchable by the occupant, i.e. in a two pane insulating glass unit where it will be on an inner surface. Additionally, the window glass itself acts as a large heat sink and rapidly dissipates the heat generated by the electric current pulse This is so because of large thermal mass of the window glass (thickness measured in mm) compared to the small mass of the phase change layer (thickness measured in nanometers). In fact, the transient high temperature of the short-duration switching process would be non-detectable to the touch on the other side of the glass.

The crystallization temperature should not be below 120° C., as otherwise, crystallization may spontaneously occur in very hot weather conditions, as could occur in the hot climate of the southern United States, for example. However, it is also desirable to have the crystallization temperature not too high and not too close to the melting temperature because it becomes more difficult to find the correct heating power for crystallization. Too low a power will not be sufficient for crystallization, and too high a power will lead to melting, which is rather used in the amorphization step. Thus, the most suitable materials, more robust for this application, should have a relatively large difference or delta between its crystallization temperature and its melting temperature. As a practical limitation, generally difference between crystallization and melting temperatures in the order of 25° C. to 50° C. should be sufficient.

The arrangement depicted in FIG. 1 may present functional issues in which one must consider, as part of the material selection process, the relative resistivity of the various layers chosen, such as in the case where the desired phase-change material has a resistivity lower than the resistivity of the selected transparent conductive layers. In that case, the transparent conductors would be heated to a temperature higher than the phase-change material, and therefore the cooling rate could be too slow to obtain the desired quenching into the amorphous phase. Therefore, in the alternative embodiment next described, in which the phase change material itself is used as a resistive heater element, the current flows through the material from one side of the film to the other.

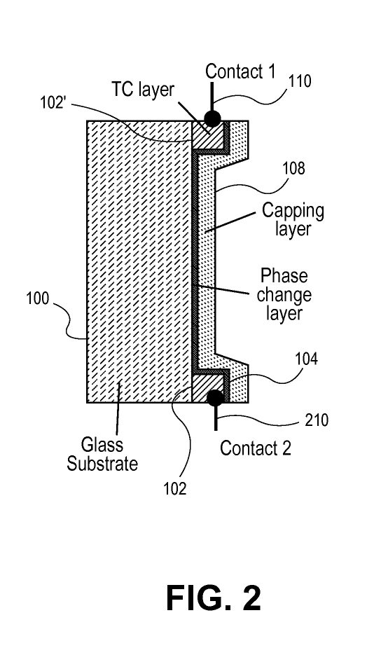

In this embodiment, two electrical contacts 110 and 210, as shown in FIG. 2 in contact with conductive strip like elements 102 and 102′. The structure of the device is extremely simple: besides glass 100, and conductive strips 102 and 102′, all that is required is the layer of phase-change material 104, conductive contacts 110 and 210, and optional optical capping layer 108 whose function is to protect the phase-change material against oxidation or other destructive influences, and it may also serve as an antireflection coating. The capping layer may be monolithic or a multilayer.

The embodiment of FIG. 2 is limited to the case when both the crystalline phase and the amorphous phase have sufficient electrical conductivity. Even as the conductivity of the amorphous phase is much reduced, one can make use of the exothermic heat of crystallization: once an area has started to switch, as it generates excess energy that can further trigger switching (crystallization) of the neighboring area. The process is sometimes called “explosive crystallization,” indicating the rapid speed of switching once initiated.

For very large area surfaces, though, the much reduced conductivity of the amorphous phase may become an issue because, with the geometry of FIG. 2, it might require a voltage that is higher than practical.

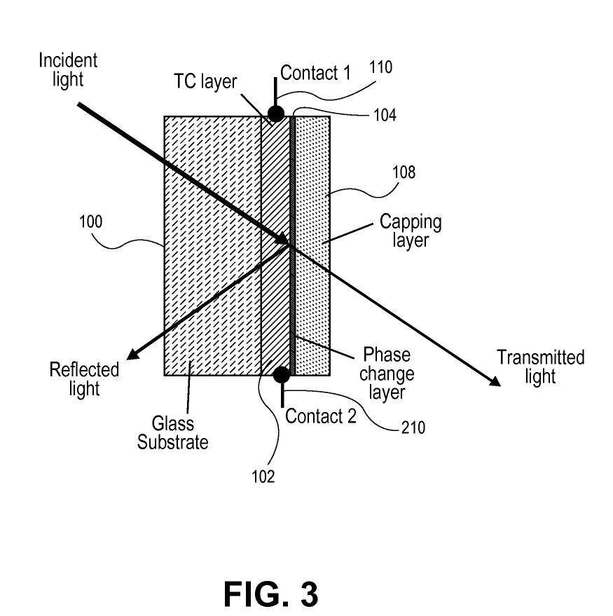

Accordingly, another embodiment is depicted in FIG. 3. Therein illustrated is a thin parallel conducting layer positioned between the glass layer and the phase transition layer 104 The thickness of this parallel layer 104 is generally about 100 nm (and within a range of 50-500 nm for typical transparent conductors) and should be, on the one hand, as thin as possible to improve the quenching behavior after the phase-change material has reached its melting temperature or above, and on the other hand, it should be thick enough too ensure optimum current transfer and power dissipation (heating) in the case where the phase-change material is highly resistive. As with the previous embodiments, the capping layer 108 serves to protect the device as well as to impart antireflection properties. In an alternative arrangement (not shown), the capping layer can be disposed on the other side of the phase change layer 104 so that the arrangement of the composite structure is glass/phase change layer/transparent conducting layer/and capping layer. In a still further variation, the conductive parallel layer and the capping layer can be one and the same.

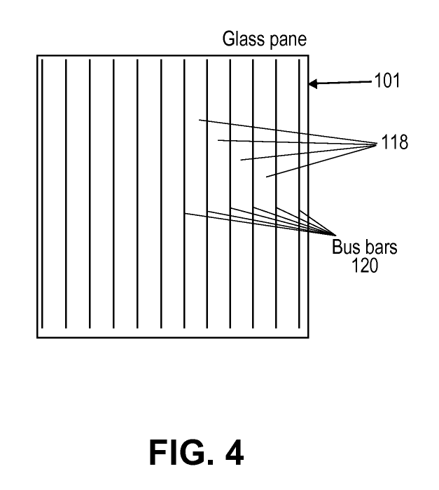

In the embodiment of FIG. 3, a transparent conducting layer is disclosed that is used to pulse-heat the phase-change layer in case the phase-change layer is too resistive to serve as the heating element itself. In fact, every low-emissivity (“low-e”) window already has at least one conducting layer that serves as the infra-red radiation mirror. The conducting layer is either a transparent conducting oxide (“hard” low-e coating) or a layer system containing at least one thin silver layer (“soft” low-e coating; the silver layer in those coatings is in the range 10-20 nm, and preferably 12-14 nm). The extension disclosed here is to utilize those conducting layers of the low emissivity coatings for carrying the current needed to heat the phase-change material. The result is an intimate coupling of phase change material and low-e coating system.

Where the resistance of the phase change material is too high, especially for the case of an embodiment as shown in FIG. 2; adequate current densities sufficient to cause melting may be achieved by segmenting the large area window 101 into smaller and more manageable sub-areas 118, as shown in FIG. 4, for example in strips that are switched by applying a voltage between bus bars 120 limiting and defining those strips. The bus bars are thin conducting layers, as indicated by the vertical lines in FIG. 4. In one preferred embodiment the material of a bus bar is a transparent conductor, e.g. a transparent conducting oxide like indium tin oxide. In another embodiment, the bus bars are thin strips of a deposited metal layer, such as copper, silver or gold, for example. In designing such an insulating glass unit, one criterion is to minimize the visibility of those bus bars. The contact areas, in FIG. 4 at the top and bottom, can be integrated into the frame of the insulating glass unit and ultimately the window frame—in this way, they are hidden.

Up to now, it was stressed that it is highly desirable to implement electrical switching of the phase-change material. While this is true, one should recall that in the information storage industry, the energy for switching is provided by a small laser. This principle can be extended to window switching, with some advantages and disadvantages. The advantages are that no electrical circuitry is needed, no contacts, bus bars, etc. The difficulty is shifted to positioning the radiative source (like a laser or flash lamp) and to precisely control the energy flux in terms of radiation intensity and duration.

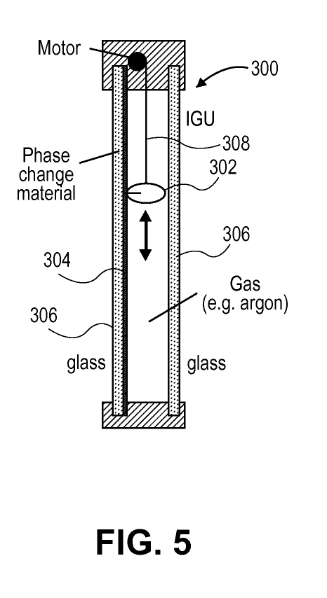

One such possible embodiment is illustrated in FIG. 5., wherein an Insulated Glass Unit (IGU) 300, the heart of a modern window, is provided with a mechanically moved radiation source 302, such as a set of solid state laser diodes, or miniature flash lights, which directs radiation energy to the phase-change material 304 which is deposited on the inside surface of glass pane 306, the application of energy causing either crystallization by relatively slow heating with modest power, or amorphization by providing a very short but intense hearting, leading to melting and quenching of the phase change material. The radiation source 302 is mounted to a movable member 308, similar to an automatically adjustable mechanical shade which is common in some IGUs today. Other, additional coatings like anti-reflection or protective coatings may be provided overtop the phase change material layer 304 (not shown in the figure).

The radiation source may be a pulsed solid state laser diode whose radiation is focused onto the phase change material using a cylindrical lens, for example, producing a line of radiation which is swept essentially perpendicular to the direction of movement of member 308. In this manner, a larger area can be covered in a short time (a minute or so for the entire window). For switching from the amorphous to the crystalline phase, the laser diode uses long pulses of relatively modest power, to raise the temperature of the phase change material to only below to the melting temperature. For switching from the crystalline to the amorphous phase the laser is pulsed with a short pulse at high power, as to lead to melting and subsequent rapid quenching of the melt. The radiation source should be selected such that no harmful radiation can escape from the window, for example, an infrared laser can be used whose radiation is reflected from a thin conducting layer deposited below the phase-change layer. Preferably, the wavelength of an infrared laser should be longer than the wavelength of absorption of the glass on which the phase change layer is deposited. For most glasses, this would be longer than 4-5 micro meters, and preferably longer than 8 micro meters. Accordingly, as the infrared wave of the laser is absorbed by glass (i.e. not transmitted), safety concerns associated with exposure to laser radiation are addressed. In the case of a UV laser, the wavelength should be shorter than the absorption edge wavelength of the glass, which is typically about 200 nm. In contrast to the information storage industry, there is no need to go to short wavelengths (like blue for Blu-Ray). Quite to the contrary, large area switching is not only acceptable but advantageous and at the heart of this invention. In yet another embodiment, the radiation source can be a pulsed flash light source because the coherence of laser light is not required for this embodiment.

Switching of the optical properties is related to changes of the electronic structure of the material, which affects both the reflectivity and the absorbance of the layer stack. The reflectivity is affected via two effects: a) a change of free carrier densities, which, among other effects, causes a well-known shift of the so-called plasma edge; and b) the change in the real part of the refractive index, n, which in turn changes the interference of light reflected from the different interfaces of the layer stack. In one state it may be optimized for antireflection (i.e. the transmitting state, associated with the amorphous phase of the phase-change material), and in the other state, the more reflecting state, associated with the crystalline phase of the phase-change material; that means, reflection by free carriers can be enforced and amplified by the interference effect.

The absorbance is also affected by the change of free carrier density and band structure, which is quantified by the imaginary part of the refractive index, k. Generally, k is smaller for the amorphous phase of the phase-change material. Therefore, having a “smart window” in mind as the main application of the phase-change device, both the reflection and absorbing properties indicate that the crystalline phase is the reflecting and absorbing state whereas the amorphous phase corresponds to the transparent, clear state.

In principle, many materials can serve as a phase-change material. However, the phase-change material needs to fulfill a number of requirements to be suitable for the application to energy-efficient windows. In the following paragraphs, those requirements are listed.

1. Phase-change materials are preferred that show a large difference in the electronic structure when changing from amorphous to crystalline or visa versa, causing large optical contrast.

2. In at least one phase (usually the amorphous), the transmittance for visible light needs to be sufficiently high to qualify the phase-change device for window applications; a transmittance of greater than 40% is desirable.

3. The phase-change material can be deposited as a thin film, with a thickness typically between 5 nm and 100 nm, and preferably about 10-15 nm.

4. The material needs to be stable in two different phases, amorphous and crystalline, of the same chemical composition, in an environmental temperature interval of interest; for window applications in buildings and vehicles that would be temperature below freezing (such as −40° C.) up to about 100° C. Stable means that the phase will not change without additional and intentional energy input.

5. The crystallization temperature, Tₓ, of the amorphous phase needs to be higher than the highest environmental temperature to avoid unwanted or uncontrolled crystallization, hence Tₓ>100° C., and even Tₓ>120° C. to be certain.

6. Having the immediately above restriction in mind, the required crystallization temperature, Tₓ, is also determined in part by the requirement that the melting temperature of amorphous phase not be too close so as to allow for the ease of crystallization when intentionally switching to the crystalline phase; subject to the further practical requirement in all cases that one should aim for Tₘ<300° C. Though Tₘ can range anywhere from 120° C-300° C., preferably Tₘ will be in the range of 160° C-250° C.

7. The melting temperature, Tₘ, needs to be significantly greater than the crystallization temperature, Tₘ>Tₓ, however, Tₘ must not be excessively high for the ease of melting when intentionally switched to the amorphous phase, as already mentioned in paragraph [0030]. While there is not a set number, generally a delta of at least 25° C-50° C. between Tₘ and Tₓ is preferred. With such a spread in temperature, the controlled changeover from one phase to the other is more easily facilitated as less precision is required in the heating step, for example, to insure that the melting temperature is not reached in transitioning from an amorphous to crystalline state.

8. The glass temperature (solidification or quenching temperature of the melt), T_{g}, needs to be sufficiently lower than then the crystallization temperature (T_{g}<Tₓ). This allows the quenched amorphous phase to exist at a temperature below the crystallization threshold.

9. Very toxic elements are not acceptable, for example arsenic (As).

10. Very expensive materials should be avoided, like Ir, Re, etc

11. Highly reactive materials should be avoided unless an economic way of addressing the reactivity is known.

True metals tend to be crystalline at room temperature and are generally not suitable (violation of requirement 5). Dielectrics like oxides tend can be amorphous or crystalline at room temperature, depending on the history of fabrication, however, the conduction band, should it exist, is not occupied and therefore there are also generally not suitable (violation of the first requirement).

The phase change layer is, in a preferred embodiment, a semi-metal. The degree of conductivity will necessarily vary with its phase: the crystalline phase being more conductive than the amorphous phase. Most suitable are certain semiconductors and semimetals (also known as metalloids), and alloys thereof. Much investigated examples are elements from columns 4A, 5A and 6A of the Periodic Table of Elements, especially Si, Ge, Sn, Pb, Sb, Bi, Te, and their compounds. Those are the classic phase change materials investigated by the information storage industry. Dopants like N, Al, Ag can be used to shift crystallization and melting temperatures; a very important concept applicable to all classes of phase-change materials.

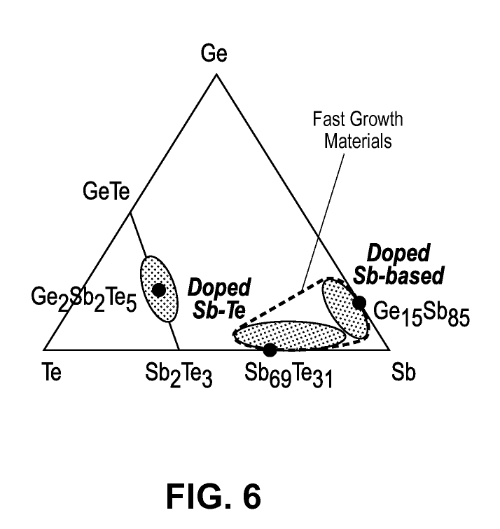

Specific examples of phase change materials for optical storage are Te₄₈As₃₀Si₁₂Ge₁₀, Te₈₁Ge₁₅Sb₂S₂, GeTe, GeTe—Sb₂Te₃, Ge₂Sb₂Te₅, GeSb₂Te₄), (Ag,In)-doped Sb₆₉Te₃₁ also known as AIST, and Ge—In—Sn—Sb. Crystallization of those materials can be quite different. Two classes are distinguished as illustrated in FIG. 6:
(1) (doped) Sb—Te materials, with composition close to the eutectic point Sb₆₉Te₃₁, showing “growth dominated crystallization”; and,
(2) compositions on the line between GeTe and Sb₂Te₃, which show “nucleation dominated crystallization”.

Materials from those classes are good candidates generally for use as the phase change material. However, when looking at the plasma edge, defined by the plasma frequency

$${ω}_{pl , e} = {( \frac{{n}_{e} {e}^{2}}{{ɛ}_{0} {m}_{e}^{*}} )}^{1 / 2}$$

one can see that this frequency corresponds to radiation too far in the infrared to obtain the best energy performance of a window. In the equation, nₑ is the density of free carriers, e=1.602×10⁻¹⁹ As is the electronic charge, ε₀=8.854×10⁻¹² As/Vm is the permittivity of free space, and m*ₑ is the effective mass, which in the metal is close but not identical to the mass of free electrons (well-known Drude model of free electrons in solids). One would need materials with a higher electron density in the crystalline phase, and this suggests looking for materials that are more metallic.

Another class of materials with greater electron concentration which can be suitable as the phase change material is the metallic glasses or amorphous metal alloys. There is a wide range of metallic glasses, including alloys of Ni, Cu, Ti, Pd, etc. Here, free electrons also exist in the conduction band of the amorphous phase, reflecting visible light. However, the concentration (density) of free electrons is much reduced compared to the crystalline phase, and this switching can occur between more (crystalline) and less (amorphous) reflectivity. The seventh requirement eliminates many of the metallic glasses because their melting temperature is too high for the practical application.

Therefore, while there are many possibilities, optimization for a particular usage/environment could start with the exploration of low melting point metals, like tin (Sn) or indium (In). In their pure metallic form they have too low a crystallization temperature (violation of the fifth requirement), as mentioned before. However, applying what is known about phase-change materials and their crystallization temperature, namely that doping or alloying with other metals can shift the crystallization temperature (up in this case), a large number of material combinations become possible. Based on a preliminary examination of binary phase diagrams; a number of specific examples suggest themselves, as listed below. This list is not intended to be complete, but it illustrative of the range of material combinations that have a suitable melting temperature for window application. Suitable candidates for amorphous metal alloys include:

alloys of Ag—In (In-rich side of eutectic point 156° C. for Ag₅In₉₅)

alloys of Ag—Sb (around eutectic point 485° C. for Ag₄₁Sb₅₉)

alloys of Ag—Sn (Sn-rich of eutectic point 221° C. for Ag₄Sn₉₆)

alloys of Ag—Te (around eutectic point 353° C. for Ag₂Te)

alloys of Au—Tl (around eutectic point 217° C. for Au₂₈Tl₇₂)

alloys of Au—Sn (around eutectic point 280° C. for Au₇₁Sn₂₉)

alloys of Au—Si (around eutectic point 363° C. for Au₈₂Si₁₈)

alloys of Au—Ge (around eutectic point 361° C. for Au_{87.5}Ge_{12.5})

alloys of Au—Bi (around eutectic point 272° C. for Au₁₄Ge₈₆)

alloys of Bi—Zn (around eutectic point 254° C. for Bi₈Zn₉₂)

alloys of Bi—Tl (around eutectic point 188° C. for BiTl)

alloys of Bi—Sn (away from eutectic point, which is very low with 139° C., for Bi₄₃Sn₅₇)

alloys of Bi—In (away from eutectic point, which is very low with 73° C., for Bi₂₂In₇₈, for example Tₘ=200° C. for BiIn₄)

alloys of Cd—Zn (around eutectic point 266° C. for Cd₇₀Zn₃₀)

alloys of Cd—Tl (around eutectic point 165° C. for Cd₈₃Tl₂₇)

alloys of Cd—Sn (around eutectic point 176° C. for Cd₃₂Sn₆₈)

alloys of Cd—Sr (around eutectic point 384° C. for Cd₂₀Sr₈₀)

alloys of Cd—Pb (around eutectic point 248° C. for Cd₂₇Pb₇₃)

alloys of Cd—Mg (monotonic melting temperature, example Tₘ=350° C. for CdMg₂)

alloys of Cu—In (around eutectic point 157° C. for Cu₂In₉₈)

alloys of Ga—Zn (monotonic melting temperature, example Tₘ=200° C. for Ga₃₀Zn₇₀)

alloys of In—Mg (Mg-rich side of eutectic point, which is at 156.6° C. for In₉₅Mg₅)

alloys of In—Pb (monotonic melting temperature, example Tₘ=220° C. for InPb)

alloys of In—Zn (Zn-rich side of eutectic point, which is at 144° C. for In₈₇Zn₁₇)

alloys of Mg—Tl (around eutectic point 202° C. for MgTl₄)

alloys of Pb—Pd (around eutectic point 260° C. for Pb_{91.6}Pd_{8.4})

alloys of Pb—Sb (around eutectic point 252° C. for Pb₈₉Sb₁₁)

alloys of Pb—Sn (around eutectic point 183° C. for Pb₂₈Sn₇₂)

alloys of Sb—Sn (monotonic melting temperature, example=250° C. for Sb₉₀Sn₁₀)

alloys of Sb—Tl (around eutectic point 195° C. for Sb₂₉Tl₃₁)

alloys of Sn—Tl (around eutectic point 168° C. for Sn₂₉Tl₃₁)

alloys of Tl—Zn (around eutectic point 304° C. for Tl₉₀Zn₁₀)

In describing the invention, the emphasis has been on the coating of glass, and its use as a component in energy efficient windows. Of course other applications are possible, such as large displays made out of a multiplicity of glass panels, where the opacity/color of each of the glass panels can be separately controlled as to its transmissivity/reflectivity according to the selected phase of the material. Other applications include panels (other than windows) that control the energy flow, which is desirable in building envelope components (exterior walls and roofs) and solar water heaters. Yet other applications are interior wall panels that control heat flow or provide privacy, or architectural or decorative glass panels which can be used to create interesting ambience effects in conference rooms, and the like. It is to be appreciated that the phase change materials can be used in connection with anything from small mirrors, or glass segments ranging in size for a square millimeter or more, to the larger commercial and industrial windows earlier described, ranging in sizes up to several square meters.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

I claim:

1. An article comprising a transparent substrate upon which has been coated with a very thin layer of a phase-change material exhibiting high resistivity and low reflectance in the amorphous state, and low resistivity and high reflectivity in the crystalline state, wherein the difference between the crystallization temperature of the phase-change material and its melting temperature is in the order of 25° C. to 50° C.

2. The article of claim 1 wherein the transparent substrate is glass.

3. The article of claim 2 wherein the transparent substrate is a window glass.

4. The article of claim 2 wherein the phase-change material is selected from a semi metal, a metal or metalloid or metal alloy composition.

5. The article of claim 4 wherein the phase-change material has a melting temperature of between 120° C. and 300° C.

6. The article of claim 5 wherein the melting temperature is between 160° C. and 250° C.

7. The article of claim 1 further including a conductive layer which is in contact with both the transparent substrate and the phase change layer.

8. The article of claim 7 wherein the conductive layer is disposed between the transparent layer and the phase change layer.

9. The article of claim 7 wherein the article further includes a capping layer disposed on the side of the phase-change layer opposite the side facing the transparent layer.

10. A method for changing the transmittance of the article of claim 1 to incident light wherein the phase of the phase change material is changed from one phase to the other by the application of short heat pulse.

11. The method of claim 10 wherein heat is applied to the phase change material by the passage of a pulse of electric current.

12. The method of claim 11 wherein a pulsed power supply is used to supply the pulse of electric current.

13. The method of claim 12 wherein the duration of the electric current pulse is in the order of less than one to one or more micro seconds.

14. The method of claim 13 wherein the duration of the cool down of the phase change material, after pulsed heating is in the order of less than one to one or more micro seconds.

15. The method of claim 10 wherein the heat is supplied by the application of a radiant energy source.

16. The method of claim 15 wherein the radiant energy source is a laser.

17. The method of claim 16 wherein the wavelength of the infrared laser is longer than the absorptive wavelength of glass on which it is deposited.

18. The method of claim 16 wherein the laser is a UV laser.

19. The method of claim 16 wherein the radiant energy source is a pulsed flash light source.

20. The method of claim 10 wherein the conversion of the phase change material from the amorphous phase to the crystalline phase is achieved by heating the material above the crystalline temperature, but below the melting temperature, followed by cooling.

21. The method of claim 10 wherein the conversion of the phase change from crystalline to amorphous comprises the rapid, pulsed heating of the material to above its melting temperature, followed by rapid cooling to quench the material, wherein both the heating and cooling steps are carried out in the order of a few microseconds.

22. An insulated glass unit comprising a frame into which two parallel panes of glass are secured in opposing positions, spaced a distance one from the other, wherein, the interior surface of at least one of the panes of glass is coated with a phase change material, and a radiation heat source is positioned within the space between the panes of glass, said radiation heat source mounted to a movable fixture designed to move the radiation source over the coated area, such as to fully subject said coated area to the radiation of the source, when activated.
